(19) United States
(12) Patent Application Publication
(10) Pub. No.: US 2010/0182473 A1
(43) Pub. Date: Jul. 22, 2010

(54) SOLID-STATE IMAGING DEVICE

(75) Inventor: Kenichi NAKAMURA, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: KABUSHIKI KAISHA TOSHIBA, Tokyo (JP)

(21) Appl. No.: 12/686,027

(22) Filed: Jan. 12, 2010

(30) Foreign Application Priority Data
Jan. 19, 2009 (JP) 2009-009285

(51) Int. Cl. H04N 5/335

(52) U.S. Cl. 348/308; 348/E05.091

(57) ABSTRACT

A solid-state imaging device includes a plurality of vertical signal lines that propagate, for respective columns of a pixel array, pixel signals from pixels, a plurality of sample-hold-signal converting circuits provided in a number larger than a number of the vertical signal lines, a plurality of switch circuits that connect one of the vertical signal lines and two or more of the sample-hold-signal converting circuits, and a control circuit that separately switches the switch circuits such that one of the vertical signal lines is connected to one of the sample-hold-signal converting circuits.

### CROSS-REFERENCE TO RELATED APPLICATIONS

This application is based upon and claims the benefit of priority from the prior Japanese Patent Application No. 2009-009285, filed on Jan. 19, 2009; the entire contents of which are incorporated herein by reference.

### BACKGROUND OF THE INVENTION

1. Field of the Invention

The present invention relates to a solid-state imaging device.

2. Description of the Related Art

In a solid-state imaging device, for example, a CMOS area sensor, sample-hold-signal converting circuits are arranged for respective columns of a pixel array in which pixels, which output voltage signals corresponding to an amount of light, are arranged in an array shape of n columns×m rows. The sample-hold-signal converting circuits corresponding to the pixels in one row selected in the pixel array capture, in the respective columns, the voltage signals output by the pixels and convert the voltage signals into digital signals. The sample-hold-signal converting circuits in selected columns sequentially output the digital signals converted by the sample-hold-signal converting circuits to a signal processing circuit and subject the digital signals to image processing to obtain a predetermined two-dimensional image.

Therefore, in the CMOS area sensor, if at least any one of the sample-hold-signal converting circuits arranged for the respective columns of the pixel array fails and does not normally operate, the quality of the generated two-dimensional image is deteriorated.

For example, Japanese Patent Application Laid-open No. 2004-327956 proposes a method of simplifying a process for manufacturing a redundant module including a fuse mounted to compensate for a defective pixel that occurs in the manufacturing process in a CMOS area sensor.

### SUMMARY OF THE INVENTION

According to one aspect of the present invention, a solid-state imaging device includes a plurality of vertical signal lines that propagate pixel signals from pixels arranged in respective columns of a pixel array; a plurality of sample-hold-signal converting circuits that receive the pixel signals from the respective vertical signal lines, the sample-hold-signal converting circuits being provided in a number larger than a number of the vertical signal lines; a plurality of switch circuits that connect the vertical signal lines and the sample-hold-signal converting circuits such that one of the vertical signal lines is connected to two or more of the sample-hold-signal converting circuits; and a control circuit that separately switches the switch circuits such that one of the vertical signal lines is connected to one of the sample-hold-signal converting circuits.

### BRIEF DESCRIPTION OF THE DRAWINGS

FIG. 1 is a block diagram illustrating the configuration of a solid-state imaging device according to a first embodiment of the present invention;

FIG. 2 is a circuit diagram illustrating a configuration example of a switching circuit shown in FIG. 1;

FIGS. 3A to 3D are diagrams for explaining an input form of a multi-input NAND of a control circuit shown in FIG. 2;

FIG. 4 is a circuit diagram illustrating a configuration example of the switching circuit shown in FIG. 1 in a second embodiment of the present invention;

FIG. 5 is a circuit diagram illustrating a configuration example of the switching circuit shown in FIG. 1 in a third embodiment of the present invention;

FIG. 6 is a circuit diagram for explaining the configuration of control circuits A shown in FIG. 5 and a relation among the control circuits A;

FIG. 7 is a circuit diagram for explaining the configuration of control circuits B shown in FIG. 5 and a relation among the control circuits B; and

FIG. 8 is a circuit diagram illustrating a configuration example of the switching circuit shown in FIG. 1 in a fourth embodiment of the present invention.

### DETAILED DESCRIPTION OF THE INVENTION

Exemplary embodiments of the present invention are explained in detail below with reference to the accompanying drawings. The present invention is not limited by the embodiments.

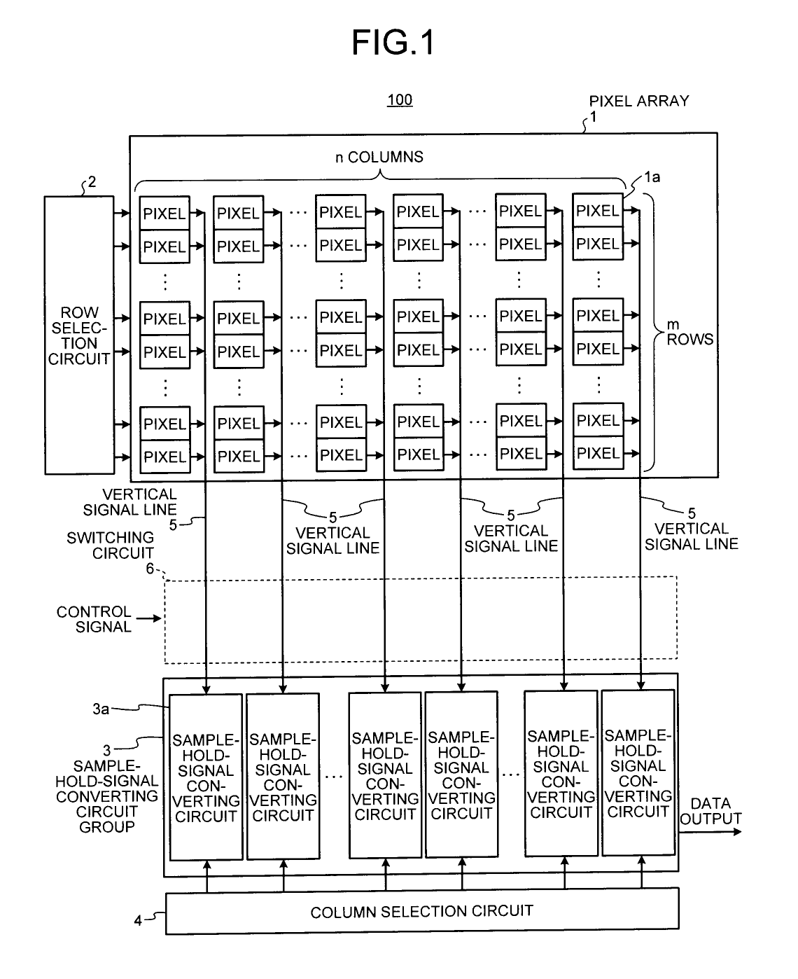

FIG. 1 is a block diagram illustrating the configuration of a solid-state imaging device according to a first embodiment of the present invention. In this embodiment, a CMOS area sensor is explained as an example of the solid-state imaging device.

In FIG. 1, a CMOS area sensor 100 includes, as basic components, a pixel array 1, a row selection circuit 2, a sample-hold-signal converting circuit group 3, and a column selection circuit 4.

In the pixel array 1, pixels la that output voltage signals corresponding to an amount of light are arranged in an array shape of n columns×m rows. Vertical signal lines 5 that lead out the output signals of the pixels la in one column to the sample-hold-signal converting circuit group 3 are provided for respective columns. The sample-hold-signal converting circuit group 3 includes n sample-hold-signal converting circuits 3a to which n vertical signal lines 5 are connected in a one-to-one relation. The row selection circuit 2 collectively selects and activates the pixels la in one row of the pixel array 1. The column selection circuit 4 separately selects and activates the n sample-hold-signal converting circuits 3a instead of performing operation for collectively selecting and activating the pixels 1a in one column of the pixel array 1.

In the CMOS area sensor 100, output signals of the pixels 1a in the pixel array 1 selected by the row selection circuit 2 are captured into the sample-hold-signal converting circuit 3a corresponding to the pixels la through the vertical signal lines 5, which are arranged for the respective columns, and converted into digital signals. The sample-hold-signal converting circuits 3a in the columns selected by the column selection circuit 4 sequentially output the converted digital signals to a not-shown signal processing circuit to form a two-dimensional image.

In the present invention, even if several one of the sample-hold-signal converting circuits 3a arranged for the respective columns of the pixel array 1 fail and do not normally operate, deterioration in the quality of the two-dimensional image generated by acquiring the digital signals from the sample-hold-signal converting circuit group 3 is prevented. As components for preventing the deterioration in the quality of the two-dimensional image, a few number of (one in the first embodiment) sample-hold-signal converting circuits are added in the sample-hold-signal converting circuit group 3 as spares. Further, as indicated by a broken line in FIG. 1, a switching circuit 6 is provided between the pixel array 1 and the sample-hold-signal converting circuit group 3.

The switching circuit 6 switches, in a quality test or the like during shipping from a factory, according to a control signal given from a host apparatus, connection between the n vertical signal lines 5 and the sample-hold-signal converting circuits in the sample-hold-signal converting circuit group 3 included the added spares while avoiding failed sample-hold-signal converting circuits to remedy the failure.

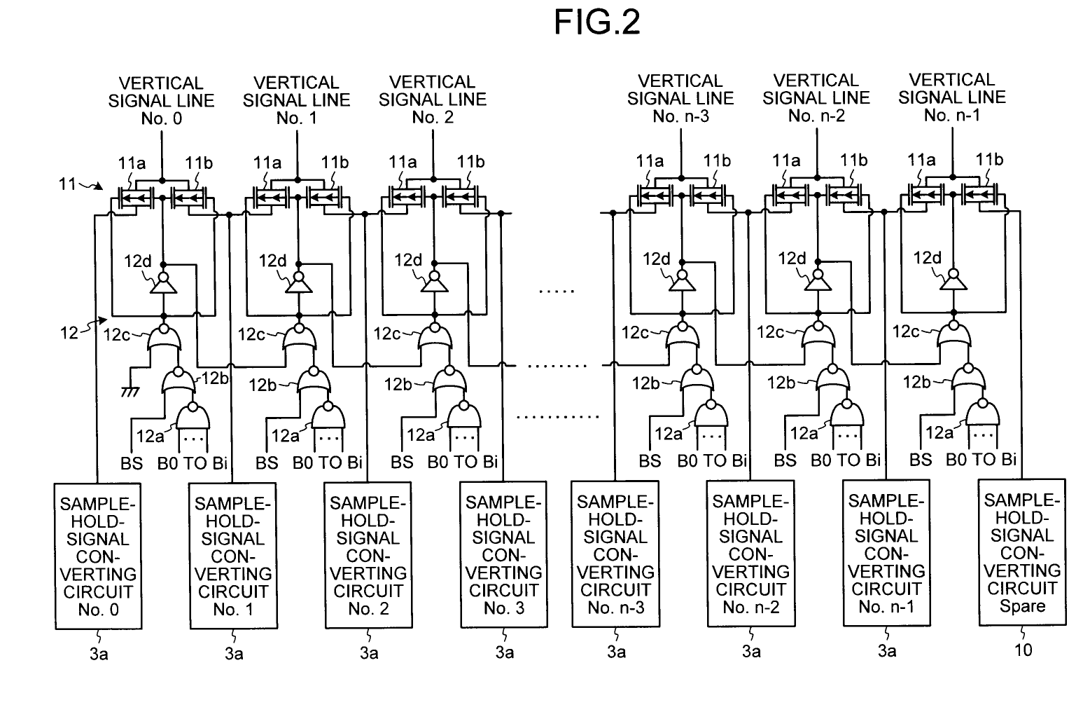

In the first embodiment, for example, the switching circuit 6 is configured as shown in FIG. 2. The other components are explained later as embodiments.

FIG. 2 is a circuit diagram illustrating a configuration example of the switching circuit 6. In FIG. 2, the n vertical signal lines 5 shown in FIG. 1 are shown as vertical signal lines No. 0 to No. n−1 from a proximal end (No. 0) to a terminal end (No. n−1) in the column direction. The n sample-hold-signal converting circuits 3a originally included in the sample-hold-signal converting circuit group 3 are shown as sample-hold-signal converting circuits No. 0 to No. n−1. One sample-hold-signal converting circuit 10 is added as a spare and is shown as a sample-hold-signal converting circuit Spare. In the example shown in the figure, the sample-hold-signal converting circuit 10 is provided on the column terminal end (No. n−1) side.

In the first embodiment, an example of a remedy method for remedying a failure of one sample-hold-signal converting circuit is explained.

In FIG. 2, the switching circuit 6 shown in FIG. 1 includes a set of an analog switch circuit 11 and a control circuit 12 as a configuration unit. Configuration units (sets of analog switch circuits 11 and control circuits 12) are provided in a one-to-one relation with the n vertical signal lines No. 0 to No. n−1.

The analog switch circuit 11 includes two analog switches 11a and 11b. Signal input terminals of the analog switches 11a and 11b are connected in common to one vertical signal line. Signal output terminals of the analog switches 11a and 11b are respectively connected to two sample-hold-signal converting circuits adjacent to each other in the column direction. As shown in FIG. 2, two analog switch circuits 11, column positions thereof are adjacent to each other, share one sample-hold-signal converting circuit as a connection switching target.

If a sign k (k=0, 1, 2, . . . , and n−1) is used for explanation, a vertical signal line No. k is connected to a sample-hold-signal converting circuit No. k and a sample-hold-signal converting circuit No. k+1 via the analog switch circuit 11 in a kth column. A vertical signal line No. k+1 is connected to a sample-hold-signal converting circuit No. k+1 and a sample-hold-signal converting circuit No. k+2 via the analog switch circuit 11 in a k+1th column. A vertical signal line No. n−1 at a column terminal end k=n−1 is connected to a sample-hold-signal converting circuit No. n−1 and the spare sample-hold-signal converting circuit Spare via the analog switch circuit 11 in a k=n−1th column.

The control circuit 12 includes, as components for causing the analog switches 11a and 11b to perform switching operation according to control signals BS and B0 to Bi input from the host apparatus, a multi-input NAND circuit 12a, NOR circuits 12b and 12c, and a logic inversion circuit 12d. “i” is a natural number and there is a relation 2ⁱ<n≦2ⁱ⁺¹ between “i” and “n”.

The control signals B0 to Bi are input to the multi-input NAND circuit 12a from the host apparatus. The NOR circuit 12b inverts an OR of the control signal BS input from the host apparatus and an output of the multi-input NAND circuit 12a and outputs the OR to one input terminal of the NOR circuit 12c. An output terminal of the NOR circuit 12c is connected to an input terminal of the logic inversion circuit 12d and control terminals on sides not opposed to each other of the analog switches 11a and 11b. An output terminal of the logic inversion circuit 12d is connected to control terminals on sides opposed to each other of the analog switches 11a and 11b.

In the n control circuits 12, the other input terminal of the NOR circuit 12c in the control circuit 12 in a k=0th column is connected to a circuit ground. An output of the logic inversion circuit 12d in the control circuit 12 in a k−1th column is input to the other input terminal of the NOR circuit 12c in the control circuit 12 in a kth column (k≧1).

The control signal BS input from the host apparatus to the NOR circuit 12b is a binary level signal indicating a High level (hereinafter, “H level”) and a Low level (hereinafter, “L level”). In the configuration example shown in FIG. 2, when no failure occurs in the sample-hold-signal converting circuits, the host apparatus maintains the control signal BS at the H level. When one sample-hold-signal converting circuit fails, the host apparatus changes the control signal BS to the L level and maintains the control signal BS at the L level.

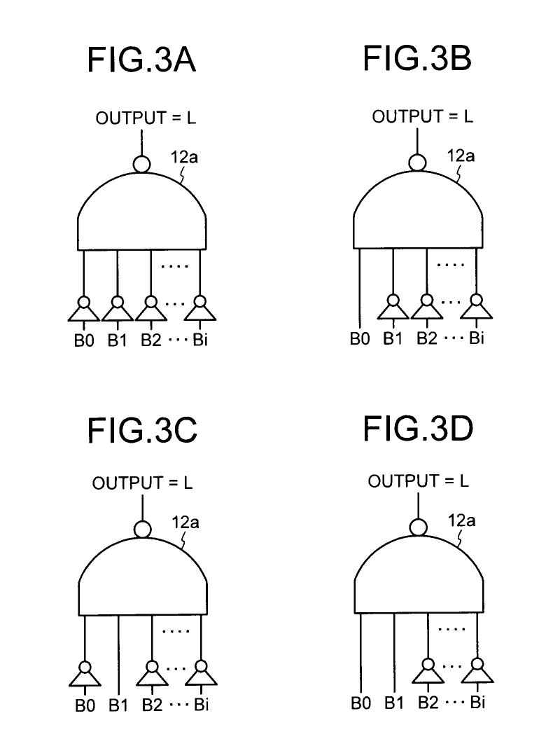

The control signals B0 to Bi input from the host apparatus to the multi-input NAND circuit 12a are signals designating, when one sample-hold-signal converting circuit fails, the control circuit 12 for the analog switch circuit 11 including the failed sample-hold-signal converting circuit as a connection switching target. Specifically, when the host apparatus designates the control circuit 12 in the kth column, in the control signals B0 to Bi input to the multi-input NAND circuit 12a in the control circuit 12 in the kth column, logical values of respective bits are set with B0 set as a least significant bit and Bi set as a most significant bit such that a value of a binary number of i+1 digits is k (see FIGS. 3A to 3D). On the other hand, when no failure occurs in the sample-hold-signal converting circuits, the host apparatus outputs the control signals B0 to Bi having arbitrary bit patterns to the multi-input NAND circuits 12a in all the control circuits 12.

FIGS. 3A to 3D are diagrams for explaining an input form of the multi-input NAND circuit 12a in the control circuit 12. In FIG. 3A, when the control circuit 12 in the k=0th column is designated, the host apparatus outputs the control signals B0 to Bi, all input bit patterns of which in the multi-input NAND circuit 12a are a negative logic. Consequently, the multi-input NAND circuit 12a in the control circuit 12 in the k=0th column sets an output to the L level. The multi-input NAND circuits 12a in the other control circuits 12 set outputs to the H level.

In FIG. 3B, when the control circuit 12 in a k=1th column is designated, the host apparatus outputs the control signals B0 to Bi, input bit patterns of which in the multi-input NAND circuit 12a are a positive logic for B0 and a negative logic for B1 to Bi. Consequently, the multi-input NAND circuit 12a in the control circuit 12 in the k=1th column set an output to the L level. The multi-input NAND circuits 12a in the other control circuits 12 set outputs to the H level.

In FIG. 3C, when the control circuit 12 in a k=2th column is designated, the host apparatus outputs the control signals B0 to Bi, input bit patterns of which in the multi-input NAND circuit 12a are a negative logic for B0, a positive logic for B1, and a negative logic for B2 to Bi. Consequently, the multi-input NAND circuit 12a in the control circuit 12 in the k=2th column sets an output to the L level. The multi-input NAND circuits 12a in the other control circuits 12 set outputs to the H level.

In FIG. 3D, when the control circuit 12 in a k=3th column is designated, the host apparatus outputs the control signals B0 to Bi, input bit patterns of which in the multi-input NAND circuit 12a are a positive logic for B0 and B1 and a negative logic for B2 to Bi. Consequently, the multi-input NAND circuit 12a in the control circuit 12 in the k=3th column sets an output to the L level. The multi-input NAND circuits 12a in the other control circuits 12 set outputs to the H level.

When no failure occurs in the sample-hold-signal converting circuits connected to the n vertical signal lines, the host apparatus sets the control signal BS to the H level, sets the control signals B0 to Bi in arbitrary bit patterns, and outputs the control signal BS and B0 to Bi.

In this case, the NOR circuits 12b in all the control circuit 12 set outputs to the L level irrespectively of output states of the multi-input NAND circuits 12a. In the control circuit 12 in the k=0th column, an output of the NOR circuit 12c is at the H level and an output of the logic inversion circuit 12d is at the L level. In the analog switch circuit 11 in the k=0th column, the analog switch 11a is turned on and the analog switch 11b is turned off. Specifically, the vertical signal line No. 0 is connected to the sample-hold-signal converting circuit No. 0 through the analog switch 11a in the analog switch circuit 11 in the k=0th column.

The L level output of the logic inversion circuit 12d in the control circuit 12 in the k=0th column is input to the NOR circuit 12c in the control circuit 12 in the k=1th column. Therefore, similarly, in the analog switch circuit 11 in the k=1th column, the analog switch 11a is turned on and the analog switch 11b is turned off. Specifically, the vertical signal line No. 1 is connected to the sample-hold-signal converting circuit No. 1 through the analog switch 11a in the analog switch circuit 11 in the k=1th column.

Thereafter, the same connecting operation is performed. In the configuration example shown in FIG. 2, all the vertical signal lines No. k (k=0 to n−1) are connected to the sample-hold-signal converting circuits No. k to which the vertical signal lines are originally connected. The sample-hold-signal converting circuit Spare is not used.

When a failure occurs in a sample-hold-signal converting circuit No. j connected to the vertical signal line in a jth column, the host apparatus sets the control signal BS to the L level, sets the control signals B0 to Bi in a bit pattern in which a value of a binary number of i+1 digits is j, and outputs the control signals BS and B0 to Bi.

Then, in the control circuit 12 in the k=0th column, an output of the NOR circuit 12c is at the H level and an output of the logic inversion circuit 12d is at the L level. The L level output of the logic inversion circuit 12d in the control circuit 12 in the k=0th column is input to the NOR circuit 12c in the control circuit 12 in the k=1th column. This relation is the same in the control circuits 12 up to a k=j−1th column. This operation is the same as the operation during no failure explained above.

Therefore, the control circuits 12 in the k=0th to j−1th columns maintain the analog switches 11a in the analog switch circuits 11 corresponding thereto on and maintain the analog switches 11b off. Consequently, the vertical signal lines No. 0 to No. j−1 are respectively connected to the sample-hold-signal converting circuit of No. 0 to No. j−1 in the same manner as during no failure.

However, in the control circuit 12 in a k=jth column, an output of the multi-input NAND circuit 12a is at the L level and an output of the NOR circuit 12b is at the H level. Therefore, an output of the NOR circuit 12c is at the L level and an output of the logic inversion circuit 12d is at the H level. Consequently, in the analog switch circuit 11 in the k=jth column, the analog switch 11a is turned off and the analog switch 11b is turned on contrary to those during no failure. Specifically, in the analog switch circuit 11 in the k=jth column, operation for switching a circuit, to which the vertical signal line No. j is connected, from the failed sample-hold-signal converting circuit No. j to the non-failed sample-hold-signal converting circuit No. j+1 is performed. Therefore, the failure in the sample-hold-signal converting circuit can be remedied.

The H level output of the logic inversion circuit 12d in the control circuit 12 in the k=jth column is input to the NOR circuit 12c in the control circuit 12 in a k=j+1th column. Therefore, in the analog switch circuit 11 in the k=j+1th column, the analog switch 11a is turned off and the analog switch 11b is turned on. Thereafter, in the analog switch circuits 11 up to the k=n−1th column, the analog switches 11a are turned off and the analog switches 11b are turned on.

Therefore, the vertical signal line No. j+1 and following vertical signal lines are switched and connected to the sample-hold-signal converting circuits from the sample-hold-signal converting circuit No. j+2 to the sample-hold-signal converting circuit Spare.

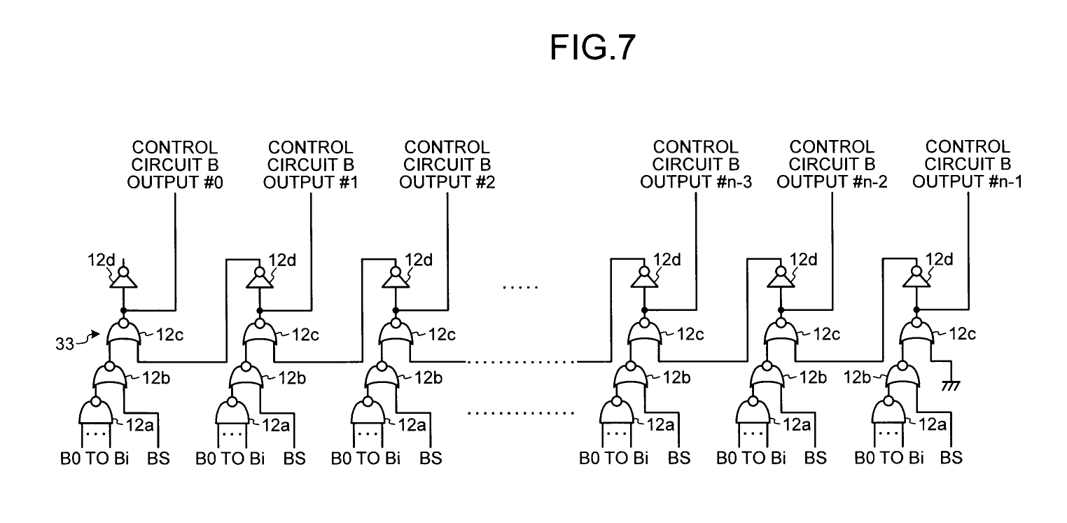

In FIG. 2, as a method of association among the n control circuits 12, an output state of the logic inversion circuit 12d at a pre-stage of a column position is input to the NOR circuit 12c at a post-stage. However, as shown in FIG. 7 referred to later, the control circuit 12 provided at a column proximal end (No. 0) and the control circuit 12 provided at a column terminal end (No. n−1) can be interchanged to input an output state of the logic inversion circuit 12d at a post-stage in a column position to the NOR circuit 12c at a pre-stage.

In FIG. 2, the n control circuits are provided independently from one another. However, n analog switch circuits 11 may be separately controlled in one control circuit.

As explained above, according to the first embodiment, the number of sample-hold-signal converting circuits is larger than the number of vertical signal lines by one and the switching of connection of the vertical signal lines and the sample-hold-signal converting circuits is performed. Each of the n analog switch circuits includes two analog switches. The sample-hold-signal converting circuits are connected to the analog switches. One sample-hold-signal converting circuit is shared by two analog switch circuits, column positions of which are adjacent to each other, as a connection switching target. For each of the analog switch circuits, the control circuit separately performs, in order of column positions, control concerning whether conduction and non-conduction of each of the two analog switches are controlled the same or inverted. The control circuit performs the control according to operation content for the other analog circuit on the column proximal end side or the column terminal end side.

Consequently, even if the sample-hold-signal converting circuit fails in an arbitrary one place in the n columns, it is possible to switch and connect the vertical signal lines to the sound sample-hold-signal converting circuits avoiding the sample-hold-signal converting circuit. Therefore, the failure in the sample-hold-signal converting circuit can be remedied.

Therefore, it is possible to correctly digitize image signals received from the vertical signal lines and output the image signals to the signal processing circuit at a post-stage without being affected by a failure in the sample-hold-signal converting circuits and prevent deterioration in the quality of a generated two-dimensional image.

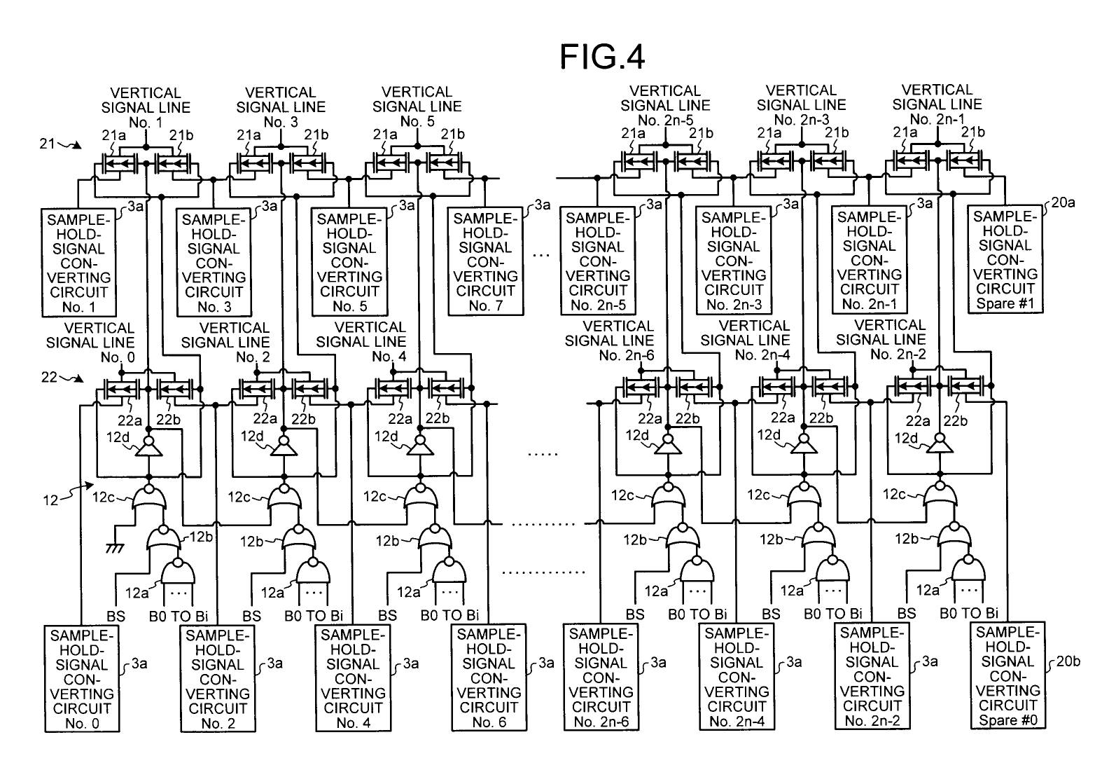

FIG. 4 is a circuit diagram illustrating a configuration example of the switching circuit shown in FIG. 1 in a second embodiment of the present invention. In the second embodiment, as a modification of the first embodiment, an example of a remedy method for remedying a failure of one or two sample-hold-signal converting circuits is explained.

In the second embodiment, the n vertical signal lines 5 shown in FIG. 1 are divided into even number columns and odd number columns. The n sample-hold-signal converting circuits 3a are also divided into even number columns and odd number columns. One sample-hold-signal converting circuit is added to each of the even number columns and the odd number columns as a spare. In FIG. 4, for convenience of explanation, n shown in FIG. 1 is replaced with 2n and an even number column side and an odd number column side are distinguished and represented.

Specifically, the n vertical signal lines 5 are divided and represented as vertical signal lines No. 0, No. 2, No. 4, . . . , No. 2n−6, No. 2n−4, and No. 2n−2 on the even number column side and vertical signal lines No. 1, No. 3, No. 5, . . . , No. 2n−5, No. 2n−3, and No. 2n−1 on the odd number column side. n+2 sample-hold-signal converting circuits including two spares are represented in the same manner.

The original sample-hold-signal converting circuits 3a on the even number column side are represented as sample-hold-signal converting circuits No. 0, No. 2, No. 4, No. 6, . . . , No. 2n−6, No. 2n−4, and No. n2−2 and added spare sample-hold-signal converting circuit 20b is represented as sample-hold-signal converting circuit Spare#0.

The original sample-hold-signal converting circuits 3a on the odd number column side are represented as sample-hold-signal converting circuits No. 1, No. 3, No. 5, No. 7, . . . , No. 2n−5, No. 2n−3, and No. 2n−1 and an added spare sample-hold-signal converting circuit 20a is represented as sample-hold-signal converting circuit Spare#1.

The analog switch circuit 11 shown in FIG. 2 is also divided and represented as an analog switch circuit 22 on the even number column side and an analog switch circuit 21 on the odd number column side. The analog switch circuit 22 includes two analog switches 22a and 22b. The analog switch circuit 21 includes two analog switches 21a and 21b.

The sample-hold-signal converting circuits No. 0, No. 2, No. 4, No. 6, . . . , No. 2n−6, No. 2n−4, and No. 2n−2 and the sample-hold-signal converting circuit Spare#0 on the even number column side are connected to the analog switch circuits 22 provided in a one-to-one relation with the vertical signal lines No. 0, No. 2, No. 4, . . . , No. 2n−6, No. 2n−4, and No. 2n−2 on the even number column side.

The sample-hold-signal converting circuits No. 1, No. 3, No. 5, No. 7, . . . , No. 2n−5, No. 2n−3, and No. 2n−1 and the sample-hold-signal converting circuit Spare#1 on the odd number column side are connected to the analog switch circuits 21 provided in a one-to-one relation with the vertical signal lines No. 1, No. 3, No. 5, . . . , No. 2n−5, No. 2n−3, and No. 2n−1 on the odd number column side.

If a sign k (k=0, 1, 2, . . . , and n−1) is used for explanation, a vertical signal line No. 2k on the even number column side is connected to a sample-hold-signal converting circuit No. 2k and a sample-hold-signal converting circuit No. 2k+2 via the analog switch circuit 22 in a 2kth column. The vertical signal line No. 2n−2 is connected to the sample-hold-signal converting circuit No. 2n−2 and the spare sample-hold-signal converting circuit Spare#0 via the analog switch circuit 22 in a k=n−1th column.

A vertical signal line No. 2k+1 on the odd number column side is connected to a sample-hold-signal converting circuit No. 2k+1 and a sample-hold-signal converting circuit No. 2k+2 via the analog switch circuit 21 in a 2k+1th column. The vertical signal line No. 2n−1 is connected to the sample-hold-signal converting circuit No. 2n−1 and the spare sample-hold-signal converting circuit Spare#1 via the analog switch circuit 21 in a k=n−1th column.

In such a connection relation, in the second embodiment, the one control circuit 12 shown in FIG. 2 controls, in the same manner, both the two analog switch circuits 22 and 21 connected to two vertical signal lines, column numbers of which are continuous. In the second embodiment, the switching circuit 6 shown in FIG. 1 includes a set of the two analog switch circuits 22 and 21 and the one control circuit 12 as a configuration unit.

When no failure occurs in the sample-hold-signal converting circuits connected to the n vertical signal lines, the host apparatus sets the control signal BS to the H level, sets the control signals B0 to Bi in arbitrary bit patterns, and outputs the control signals BS and B0 to Bi.

In this case, in the two analog switch circuits 22 and 21 to which the vertical signal lines, column numbers of which are continuous, the analog switches 22a and 21a are turned on and the analog switches 22b and 21b are turned off.

Therefore, on the even number column side, the vertical signal lines in the even number columns are connected to the sample-hold-signal converting circuits in the even number columns corresponding thereto. The sample-hold-signal converting circuit Spare#0 is not used. On the odd number column side, the vertical signal lines in the odd number columns are connected to the sample-hold-signal converting circuits in the odd number columns corresponding thereto. The sample-hold-signal converting circuit Spare#1 is not used. A connection state is the same as that in the first embodiment on the even number column side and the odd number column side.

In this state, when a failure occurs in one or both of sample-hold-signal converting circuits No. 2j and No. 2+1j connected to a vertical signal lines in the k=2jth column and a k=2j+1th column, the control circuit 12 corresponding thereto is the control circuit 12 in the k=jth column. Therefore, the host apparatus sets the control signal BS to the L level, sets the control signals B0 to Bi in a bit pattern in which a value of a binary number of i+1 digits is j, and outputs the control signals BS and B0 to Bi.

Then, in the control circuits 12 in k=0th to 2j−1th columns, outputs of the multi-input NAND circuits 12a are at the H level. Therefore, the analog switches 22a and 21a in the analog switch circuits 22 and 21 corresponding thereto are turned on and the analog switches 22b and 21b in the analog switch circuits 22 and 21 are turned off. Consequently, vertical signal lines No. 0 to No. 2j−1 are respectively connected to sample-hold-signal converting circuits No. 0 to No. 2j−1 in the same manner as during no failure.

However, in the control circuit 12 in the k=jth column, an output of the multi-input NAND circuit 12a is at the L level. Therefore, in the analog switch circuit 22 in the k=2jth column and the analog switch circuit 21 in the k=2j+1th column, the analog switches 22a and 21a are turned off and the analog switches 22b and 21b are turned on contrary to those during no failure.

Specifically, in the analog switch circuit 22 in the k=2jth column, operation for switching a circuit, to which the vertical signal line No. 2j is connected, from the sample-hold-signal converting circuit No. 2j to a sample-hold-signal converting circuit No. 2j+2 is performed. In the analog switch circuit 21 in the k=2j+1th column, operation for switching a circuit, to which a vertical signal line No. 2j+1 is connected, from the sample-hold-signal converting circuit No. 2j+1 to a sample-hold-signal converting circuit No. 2j+3 is performed.

In this way, when a failure occurs in one or both of the sample-hold-signal converting circuits No. 2j and No. 2j+1 connected to the vertical signal lines in the k=2jth column and the k=2j+1th column, the sample-hold-signal converting circuits No. 2j and the sample-hold-signal converting circuit No. 2j+1 are excluded from connection targets in the assumption that failures occur therein. Therefore, it is possible to remedy a failure that occurs in one or both of the two sample-hold-signal converting circuits, column numbers of which are continuous.

The H level output of the logic inversion circuit 12d in the control circuit 12 in the k=jth column is input to the NOR circuit 12c in the control circuit 12 in the k=j+1th column. Therefore, in the analog switch circuit 22 in the k=2jth column and the analog switch circuit 21 on the k=2j+1th column, the analog switches 22a and 21a are turned off and the analog switches 22b and 21b are turned on. Thereafter, in the analog switch circuits 22 up to a k=2n−2th column and the analog switch circuits 21 up to a k=2n−1th column, similarly, the analog switches 22a and 21a are turned off and the analog switches 22b and 21b are turned on.

Therefore, a vertical signal line No. 2j+2 and following vertical signal lines are switched and connected to the sample-hold-signal converting circuits from a sample-hold-signal converting circuit No. 2j+2 to the sample-hold-signal converting circuit Spare#0. A vertical signal line No. 2j+3 and following vertical signal lines are connected and switched to the sample-hold-signal converting circuits from a sample-hold-signal converting circuit No. 2j+3 to the sample-hold-signal converting circuit Spare#1.

As explained above, according to the second embodiment, the n vertical signal lines are divided into the even number columns and the odd number columns. The n sample-hold-signal converting circuits are divided into the even number columns and the odd number columns. One sample-hold-signal converting circuit is added to each of the even number columns and the odd number columns as the spare. In the analog switch circuits provided on the even number column side and the analog switch circuits provided on the odd number column side, the two analog switch circuits connected to the two vertical signal lines, column numbers of which are continuous, are controlled in the same manner by the one control circuit.

Consequently, when a failure occurs in one or both of the two sample-hold-signal converting circuits, column numbers of which are continuous, connection switching for excluding both the sample-hold-signal converting circuits from connection targets can be performed. Therefore, when a failure occurs in one arbitrary place in the nth column or when failures occur in two places, column numbers of which are continuous, it is possible to remedy the failures.

Therefore, as in the first embodiment, it is possible to correctly digitize image signals received from the vertical signal lines and output the image signals to the signal processing circuit at a post-stage without being affected by a failure in the sample-hold-signal converting circuits and prevent deterioration in the quality of a generated two-dimensional image.

In addition, in the second embodiment, it is necessary to prepare two spare sample-hold-signal converting circuits. However, only one control circuit for controlling the analog switch circuits has to be provided for two analog switch circuits. Therefore, the number of control circuits is halved and simplification of a configuration can be realized compared with the first embodiment in which the control circuits are provided for the respective analog switch circuits. The number of necessary bits of a control signal used by the host apparatus to designate a control circuit can be smaller by one bit compared with the first embodiment.

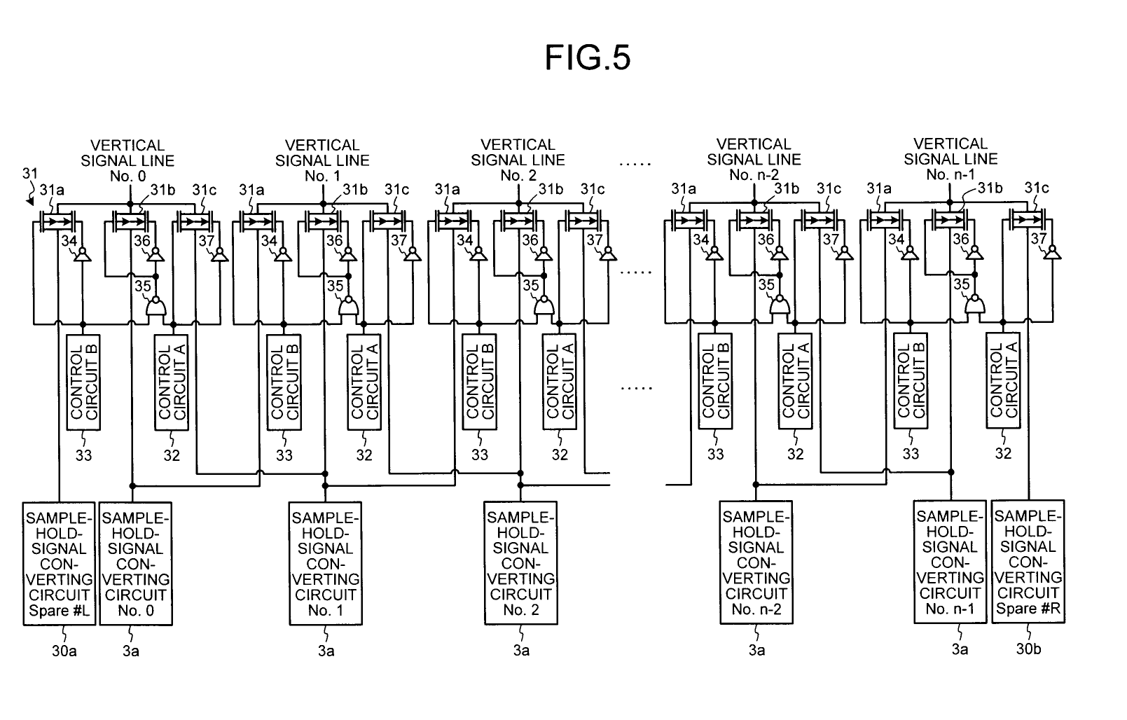

FIG. 5 is a circuit diagram illustrating a configuration example of the switching circuit shown in FIG. 1 in a third embodiment of the present invention. In the third embodiment, an example of a remedy method for remedying a failure of one or two sample-hold-signal converting circuits is explained as the extension of the first embodiment.

As shown in FIG. 5, in the third embodiment, two sample-hold-signal converting circuits 30a and 30b are added as spares. In FIG. 5, the sample-hold-signal converting circuits 30a and 30b are arranged on both end sides in the column direction. The sample-hold-signal converting circuit 30a arranged on the column proximal end (No. 0) side is represented as sample-hold-signal converting circuit Spare#L and the sample-hold-signal converting circuit 30b arranged on the column terminal end (No. n−1) side is represented as sample-hold-signal converting circuit Spare#R.

The configuration unit of the switching circuit 6 shown in FIG. 1 is a set of an analog switch circuit 31 and two control circuits (a control circuit A 32 and a control circuit B 33) instead of the set of the analog switch circuit 11 and the control circuit 12 shown in FIG. 2. The analog switch circuit 31 includes three analog switches 31a, 31b, and 31c.

In the set of the analog switch circuit 31 and the two control circuits (the control circuit A 32 and the control circuit B 33) corresponding to the vertical signal line No. 0, signal input terminals of the three analog switches 31a, 31b, and 31c are connected in common to the vertical signal line No. 0. The sample-hold-signal converting circuit Spare#L is connected to a signal output terminal of the analog switch 31a. The sample-hold-signal converting circuit No. 0 is connected to a signal output terminal of the analog switch 31b. The sample-hold-signal converting circuit No. 1 is connected to a signal output terminal of the analog switch 31c.

An output terminal of the control circuit B 33 is directly connected to one control terminal of the analog switch 31a, connected to the other control terminal of the analog switch 31a via a logic inversion circuit 34, and connected to one input terminal of a NAND circuit 35. An output terminal of the NAND circuit 35 is directly connected to one control terminal of the analog switch 31b, connected to the other control terminal of the analog switch 31b via a logic inversion circuit 36, and connected to the other control terminal of the analog switch 31c via a logic inversion circuit 37.

Specifically, in the set of the analog switch circuit 31 and the two control circuits (the control circuit A 32 and the control circuit B 33) corresponding to the vertical signal line No. 0, the vertical signal line No. 0 is switched and connected to any one of the three sample-hold-signal converting circuits (Spare#L, No. 0, and No. 1) via the analog switch circuit 31.

In a set of the analog switch circuit 31 and the two control circuits (the control circuit A 32 and the control circuit A33) corresponding to the vertical signal line No. 1, in the same connection relation, the vertical signal line No. 1 is switched and connected to any one of the three sample-hold-signal converting circuits (No. 0, No. 1, and No. 2) via the analog switch circuit 31.

As explained above, the number of sample-hold-signal converting circuits as connection switching targets in the set of the analog switch circuit 31 and the two control circuits (the control circuit A 32 and the control circuit B 33), which is the configuration unit of the switching circuit 6, is three in both the set corresponding to the vertical signal line No. 0 and the set corresponding to the vertical signal line No. 1. However, the two sample-hold-signal converting circuits No. 0 and No. 1 among the sample-hold-signal converting circuits are redundantly connected. This redundant connection relation of the two sample-hold-signal converting circuits is the same in sets of the analog switch circuit 31 and the two control circuits (the control circuit A 32 and the control circuit B 33) in the respective columns.

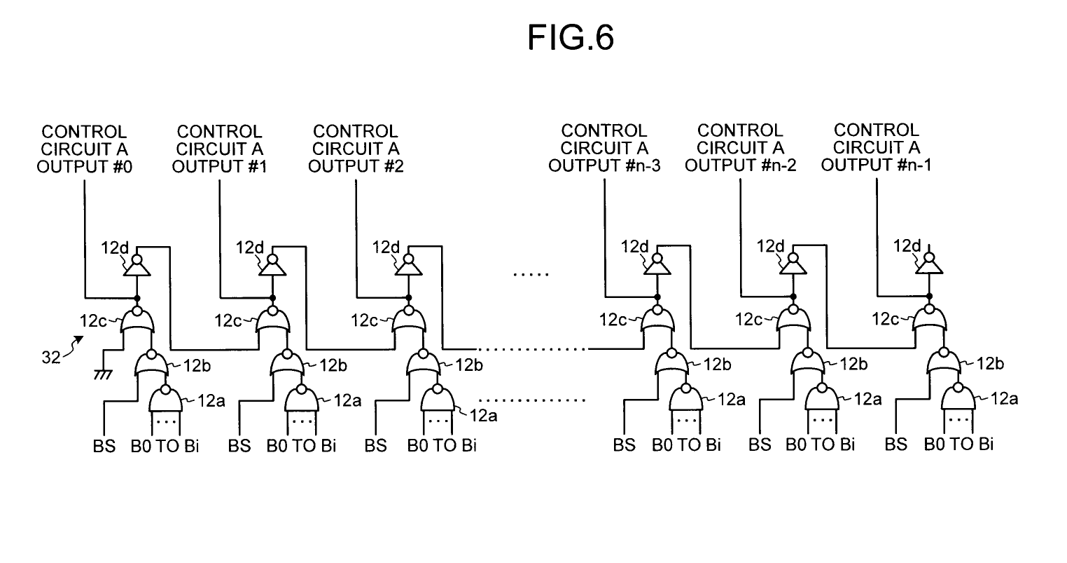

FIG. 6 is a circuit diagram for explaining the configuration of the control circuits A 32 and a relation among the control circuits A 32. FIG. 7 is a circuit diagram for explaining the configuration of the control circuits B 33 and a relation among the control circuits B 33.

As shown in FIGS. 6 and 7, the control circuit A 32 and the control circuit B 33 have configurations same as the configuration of the control circuit 12 shown in FIG. 2. Therefore, components of the control circuits A 32 and B 33 are denoted by the same reference numerals and signs and explanation of the components is omitted. As in the control circuit 12 shown in FIG. 2, the control signals BS and B0 to Bi are input from the host apparatus. However, the host apparatus separately outputs the control signals BS and B0 to Bi to n control circuits A 32 and n control circuits B 33.

As shown in FIGS. 6 and 7, the control circuit A 32 and the control circuit B 33 extract outputs to the analog switch circuit 31 in ways different from the way of extraction of an output by the control circuit 12 shown in FIG. 2. Specifically, each of the control circuit A 32 and the control circuit B 33 extracts an output of the NOR circuit 12c as outputs (#0 to #n−1) to the analog switch circuit 31 and does not extract an output of the logic inversion circuit 12d as outputs to the analog switch circuit 31.

As shown in FIGS. 6 and 7, a way of association among the control circuits A 32 and a way of association among the control circuits B 33 are opposite. As shown in FIG. 6, among the n control circuits A 32, in the same manner as among the control circuits 12 shown in FIG. 2, the other input terminal of the NOR circuit 12c in the control circuit A 32 arranged on the column proximal end (No. 0) side is connected to a circuit ground. An output of the logic inversion circuit 12d is input to the other input terminal of the NOR circuit 12c in the control circuit A 32 arranged in the next column No. 1. Thereafter, in the same manner, output states of the logic inversion circuits 12d as operation contents are sequentially transmitted from the column proximal end (No. 0) side to the column terminal end (No. n−1) side.

On the other hand, as shown in FIG. 7, among the n control circuits B 33, the other input terminal of the NOR circuit 12c in the control circuit B 33 arranged at the column terminal end No. n−1 is connected to a circuit ground. An output of the logic inversion circuit 12d is input to the other input terminal of the NOR circuit 12c in the control circuit B 33 arranged in the immediately preceding column No. n−2. Thereafter, in the same manner, output states of the logic inversion circuits 12d as operation contents are sequentially transmitted from the column terminal end (No. n−1) side to the column proximal end (No. 0) side.

When no failure occurs in the sample-hold-signal converting circuits connected to the n vertical signal lines, the host apparatus sets the control signal BS to the H level, sets the control signals B0 to Bi in arbitrary bit patterns, and outputs the control signal BS and B0 to Bi.

In this case, the NOR circuits 12b in all the control circuits A 32 and control circuit B 33 set outputs to the L level irrespectively of output states of the multi-input NAND circuits 12a. In the control circuit A 32 and the control circuit B 33 in the kth column, an output of the NOR circuit 12c is at the H level and an output of the logic inversion circuit 12d is at the L level. Consequently, in the analog switch circuit 31 in the kth column, the analog switch 31a is turned off, the analog switch 31b is turned on, and the analog switch 31c is turned off.

Specifically, when no failure occurs in the sample-hold-signal converting circuits connected to the n vertical signal lines, in all k=0 to n−1, the vertical signal line No. k is connected to the original sample-hold-signal converting circuit No. k through the analog switch 31b in the analog switch circuit 31 in the kth column. Both the added sample-hold-signal converting circuits Spare#L and Spare#R are not used.

In this state, when failures occur in two sample-hold-signal converting circuits No. h and No. j connected to two vertical signal lines in a k=hth column and a k=jth column (h<j), the host apparatus sets the control signal BS to the L level and outputs the control signal BS to the n control circuits A 32 and the n control circuits B 33. The host apparatus sets the control signals B0 to Bi in a bit pattern in which a value of a binary number of i+1 digits is h and outputs the control signals B0 to Bi to the n control circuits B 33. The host apparatus sets the control signals B0 to Bi in a bit pattern in which a value of a binary number of i+1 digits and outputs the control signals B0 to Bi to the n control circuits A 32.

Then, in the n control circuits B 33, an output of the multi-input NAND circuit 12a in the control circuit B 33 in the k=hth column is at the L level. In the n control circuits A 32, an output of the multi-input NAND circuit 12a in the control circuit A 32 in the k=jth column is at the L level. Therefore, outputs to the analog switch circuits 31 (outputs of the NOR circuits 12c) corresponding to the control circuits are at the L level.

As shown in FIG. 7, an output of the control circuit B 33 in the k=hth column is inverted by the logic inversion circuit 12d and input to the NOR circuit 12c in the control circuit B 33 in a k=h−1th column. Therefore, outputs of the control circuits B 33 in the k=0 to h−1th columns to the analog switch circuits 31 corresponding thereto are also at the L level. On the other hand, outputs of the control circuits B 33 in the k=h+1 to n−1th columns to the analog switch circuits 31 corresponding thereto are at the H level.

As shown in FIG. 6, an output of the control circuit A 32 in the k=jth column is inverted by the logic inversion circuit 12d and input to the NOR circuit 12c in the control circuit A 32 in the k=j+1th column. Therefore, outputs of the control circuits A 32 in the k=j+1 to n−1th columns are also at the L level. On the other hand, outputs of the control circuits A 32 in the k=0 to j−1th columns to the analog switch circuits 31 corresponding thereto are at the H level.

Therefore, in the analog switch circuits 31 connected to the vertical signal lines No. 0 to No. h, the analog switches 31a are turned on and the analog switches 31b and 31c are turned off. Therefore, the vertical signal lines No. 0 to No. h are switched from the sample-hold-signal converting circuits No. 0 to No. h to the sample-hold-signal converting circuits Spare#L and No. 0 to No. h−1 and connected to the sample-hold-signal converting circuits Spare#L and No. 0 to No. h−1. The first failure that occurs in the k=hth column is remedied.

In the analog switch circuits 31 connected to the vertical lines No. h+1 to No. j−1, outputs of the control circuits A 32 and the control circuits B 33 to the analog switch circuits 31 corresponding thereto are at the H level. Therefore, the analog switches 31b are turned on, both the analog switches 31a and 31c are turned off, and the vertical signal lines No. h+1 to No. j−1 are maintained to be connected to the original sample-hold-signal converting circuits No. h+1 to No. j−1.

In the analog switch circuits 31 connected to the vertical signal lines No. j to No. n−1, outputs of the control circuits B 33 to the analog switch circuits 31 corresponding thereto are at the H level and outputs of the control circuits A 32 to the analog switch circuits 31 corresponding thereto are at the L level. Therefore, the analog switches 31c are turned on and both the analog switches 31a and 31b are turned off. Therefore, the vertical signal lines No. j to No. n−1 are switched from the sample-hold-signal converting circuits No. j to No. n−1 to the sample-hold-signal converting circuits No. j+1 to No. n−1 and Spare#R and connected to the sample-hold-signal converting circuits No. j+1 to No. n−1. The second failure that occurs in the k=jth column is remedied.

When a failure occurs in one of the sample-hold-signal converting circuits connected to the n vertical signal lines, for example, when a failure occurs in the sample-hold-signal converting circuit in the k=jth column, the failure can be remedied by any one of operation (1) and operation (2) explained below.

(1) The host apparatus sets the control signal BS to the H level, sets the control signals B0 to Bi in arbitrary bit patterns, and outputs the control signals BS and B0 to Bi to the n control circuits B 33. The host apparatus sets the control signal BS to the L level, sets the control signals B0 to Bi in a bit pattern in which a value of a binary number of i+1 digits is j, and outputs the control signals BS and B0 to Bi to the n control circuits A 32.

Then, the vertical signal lines No. 0 to No. j−1 are maintained to be connected to the original sample-hold-signal converting circuits No. 0 to No. j−1. However, the vertical signal lines No. j to No. n−1 are switched from the sample-hold-signal converting circuits No. j to No. n−1 to the sample-hold-signal converting circuits No. j+1 to No. n−1 and Spare#R and connected to the sample-hold-signal converting circuits No. j+1 to No. n−1 and Spare#R. The failure is remedied. A connection state in this case is the same as the connection state in the first embodiment.

(2) The host apparatus sets the control signal BS to the H level, sets the control signals B0 to Bi in arbitrary bit patterns, and outputs the control signals BS and B0 to Bi to the n control circuits A 32. The host apparatus sets the control signal BS to the L level, sets the control signals B0 to Bi in a bit pattern in which a value of a binary number of 1+1 digits is j, and outputs the control signals BS and B0 to Bi to the n control circuits B 33.

In this case, contrary to (1) above, the vertical signal lines No. j+1 to No. n−1 are maintained to be connected to the original sample-hold-signal converting circuits No. j+1 to No. n−1. However, the vertical signal lines No. 0 to No. j are switched from the sample-hold-signal converting circuits No. 0 to No. j to the sample-hold-signal converting circuits Spare#L and No. 0 to No. j−1 and connected to the sample-hold-signal converting circuits Spare#L and No. 0 to No. j−1. The failure is remedied.

As explained above, according to the third embodiment, the two sample-hold-signal converting circuits are added. Each of the n analog switch circuits includes the three analog switches. The sample-hold-signal converting circuits are connected to the analog switches. Two sample-hold-signal converting circuits adjacent to each other in the column direction are shared as connection switching targets between two analog switch circuits, column positions of which are adjacent to each other. For each of the analog switch circuits, the two control circuits separately perform, in order of the column positions, control concerning whether conduction and non-conduction of each of the three analog switches are controlled in the same manner or inverted. One control circuit performs the control according to operation content for the other analog circuit on the column proximal end side. The other control circuit performs the control according to operation content for the other analog circuit on the column terminal end side.

Consequently, even if one or two sample-hold-signal converting circuits fail in arbitrary places in the n columns, it is possible to switch and connect the vertical signal lines to the sound sample-hold-signal converting circuits avoiding the sample-hold-signal converting circuits. Therefore, the failure(s) in the sample-hold-signal converting circuits can be remedied. As in the first embodiment, it is possible to prevent deterioration in the quality of a two-dimensional image.

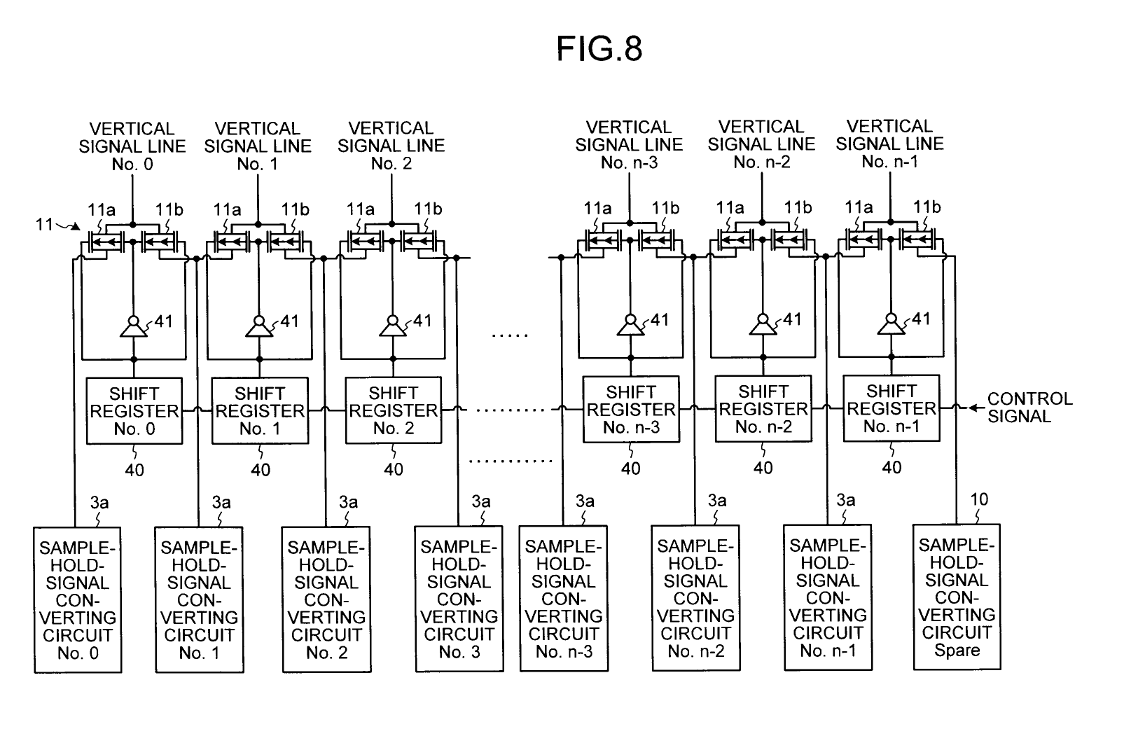

FIG. 8 is a circuit diagram illustrating a configuration example of the switching circuit shown in FIG. 1 in a fourth embodiment of the present invention. In the fourth embodiment, another configuration example of the control circuit explained in the first to third embodiments is explained.

As shown in FIG. 8, in the fourth embodiment, as a configuration example of the switching circuit 6 shown in FIG. 1, n shift registers 40 and n logic inversion circuits 41 are provided instead of the n control circuits 12 in the configuration shown in FIG. 2 (the first embodiment).

The shift registers 40 have n shift stages (No. 0 to No. n−1). In the example shown in the figure, a control signal is input from the column terminal end (No. n−1) side. An output from each of shift stages (No. 0 to No. n−1) of the shift registers 40 is input to control terminals on sides not opposed to each other of the analog switches 11a and 11b included in the analog switch circuit 11 corresponding to the shift stage. The output is input to control terminals opposed to each other of the analog switches 11a and 11b via the logic inversion circuit 41.

When no failure occurs in the sample-hold-signal converting circuits connected to the n vertical signal lines, the host apparatus inputs a control signal, all n bits of which are “1”, from the column end terminal side of the shift registers 40 such that all the shift stages of the shift registers 40 outputs the H level (“1”).

Then, in the analog switch circuits 11, the analog switches 11a are turned on and the analog switches 11b are turned off. Consequently, as in the first embodiment, all the vertical signal lines No. k in the k=0th to n−1th columns are connected to the sample-hold-signal converting circuits No. k. The sample-hold-signal converting circuit Spare is not used.

In this state, when a failure occurs in the sample-hold-signal converting circuit No. j connected to the vertical signal line in the k=jth column, the host apparatus inputs, from the column terminal end (No. n−1) side of the shift registers 40, an n-bit control signal with a logic value set such that the shift stages (No. 0 to No. j−1) of the shift registers 40 output the H level (“1”) and the shift stages (No. j to No. n−1) output the L level (“0”).

Then, in the analog switch circuits 11 connected to the vertical signal lines No. 0 to No. j−1, the analog switch 11a is maintained to be on and the analog switch 11b is maintained to be off. As explained above, the vertical signal lines No. 0 to No. j−1 are respectively maintained to be connected to the original sample-hold-signal converting circuits No. 0 to No. j−1.

On the other hand, in the analog switch circuits 11 connected to the vertical signal lines No. j to No. n−1, the analog switches 11a are switched to off and the analog switches 11b are switched to on. Consequently, the vertical signal lines No. j to No. n−1 are switched from the sample-hold-signal converting circuits No. j to No. n−1 to the sample-hold-signal converting circuits No. j+1 to No. n−1 and Spare and connected to the sample-hold-signal converting circuits No. j+1 to No. n−1 and Spare. A failure that occurs in the sample-hold-signal converting circuits is remedied.

As explained above, according to the fourth embodiment, even if a sample-hold-signal converting circuit fails in one arbitrary place in the n columns, with a configuration simpler than the configurations according to the first to third embodiment, it is possible to switch and connect the vertical signal lines to sound sample-hold-signal converting circuits avoiding the sample-hold-signal converting circuit. Therefore, it is possible to remedy the failure that occurs in the sample-hold-signal converting circuit and prevent deterioration in the quality of a two-dimensional image as in the first embodiment.

In the fourth embodiment, the example of application to the first embodiment is explained. It goes without saying that the fourth embodiment can be applied to the second to third embodiments in the same manner.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A solid-state imaging device comprising:
a plurality of vertical signal lines that propagate pixel signals from pixels arranged in respective columns of a pixel array;
a plurality of sample-hold-signal converting circuits that receive the pixel signals from the respective vertical signal lines, the sample-hold-signal converting circuits being provided in a number larger than a number of the vertical signal lines;
a plurality of switch circuits that connect the vertical signal lines and the sample-hold-signal converting circuits such that one of the vertical signal lines is connected to two or more of the sample-hold-signal converting circuits; and
a control circuit that separately switches the switch circuits such that one of the vertical signal lines is connected to one of the sample-hold-signal converting circuits.

2. The solid-state imaging device according to claim 1, wherein
the switch circuits include, as a set, a plurality of switches respectively connected to one of the vertical signal lines and are arranged in a one-to-one relation with the vertical signal lines such that one of the sample-hold-signal converting circuits is connected to each of the switches and one or more of the sample-hold-signal converting circuits are shared between the switch and another switch, column positions of which are adjacent to each other, and
the control circuit reverses, between time when operation designation is received according to a control signal from an outside and time when the operation designation is not received, control of conduction and non-conduction of each of the switches in the switch circuits corresponding to the control circuit and performs, in order of column positions, according to operation content for another switch circuit adjacent on a column proximal end side or a column terminal end side, control concerning whether the conduction and non-conduction is performed the same as the other switch circuit or reversed.

3. The solid-state imaging device according to claim 1, wherein
the switch circuits include, as a set, a plurality of switches respectively connected to one of the vertical signal lines and are arranged in a one-to-one relation with the vertical signal lines such that one of the sample-hold-signal converting circuits is connected to each of the switches and one or more of the sample-hold-signal converting circuits are shared between the switch and another switch, column positions of which are adjacent to each other, one of the sample-hold-signal converting circuits in even number columns being connected to each of the switches when a column number of the vertical signal line to which the switch is connected is an even number and one of the sample-hold-signal converting circuits in an odd number column being connected to each of the switches when a column number of the vertical signal line to which the switch is connected is an odd number, and
the control circuit reverses, between time when operation designation is received according to a control signal from an outside and time when the operation designation is not received, control of conduction and non-conduction of each of the switches in the switch circuits corresponding to the control circuit, performs, in order of column positions, according to operation content for another switch circuit adjacent on a column proximal end side or a column terminal end side, control concerning whether the conduction and non-conduction is performed the same as the other switch circuit or reversed, and performs same switching control for each two of the switch circuits connected to two of the vertical signal lines, column numbers of which are continuous.

4. The solid-state imaging device according to claim 1, wherein
the switch circuits include, as a set, a plurality of switches respectively connected to one of the vertical signal lines and are arranged in a one-to-one relation with the vertical signal lines such that one of the sample-hold-signal converting circuits is connected to each of the switches and one or more of the sample-hold-signal converting circuits are shared between the switch and another switch, column positions of which are adjacent to each other, and
the control circuit reverses, between time when operation designation is received according to a control signal from an outside and time when the operation designation is not received, control of conduction and non-conduction of each of the switches in the switch circuits corresponding to the control circuit, performs, in order of column positions, according to operation content for another switch circuit adjacent on a column proximal end side or a column terminal end side, control concerning whether the conduction and non-conduction is performed the same as the other switch circuit or reversed, and includes, in the order of the column positions, a first control circuit with the other switch circuit set on the column proximal end side and a second control circuit with the other switch circuit set on the column terminal end side, the first control circuit and the second control circuit controlling different switches among the switches in the switch circuits corresponding to the control circuits.

5. The solid-state imaging device according to claim 1, wherein
the switch circuits include, as a set, a plurality of switches respectively connected to one of the vertical signal lines and are arranged in a one-to-one relation with the vertical signal lines such that one of the sample-hold-signal converting circuits is connected to each of the switches and one or more of the sample-hold-signal converting circuits are shared between the switch and another switch, column positions of which are adjacent to each other, and
the control circuit includes a shift register that separately controls conduction and non-conduction of each of the switches of the switch circuits according to a control signal from an outside.

6. The solid-state imaging device according to claim 1, wherein
the switch circuits include, as a set, a plurality of switches respectively connected to one of the vertical signal lines and are arranged in a one-to-one relation with the vertical signal lines such that one of the sample-hold-signal converting circuits is connected to each of the switches and one or more of the sample-hold-signal converting circuits are shared between the switch and another switch, column positions of which are adjacent to each other, one of the sample-hold-signal converting circuits in even number columns being connected to each of the switches when a column number of the vertical signal line to which the switch is connected is an even number and one of the sample-hold-signal converting circuits in an odd number column being connected to each of the switches when a column number of the vertical signal line to which the switch is connected is an odd number, and
the control circuit includes a shift register that separately controls conduction and non-conduction of each of the switches of the switch circuits according to a control signal from an outside, the shift register performing same switching control for each two of the switch circuits connected to two of the vertical signal lines, column numbers of which are continuous.

7. The solid-state imaging device according to claim 1, wherein
the switch circuits include, as a set, a plurality of switches respectively connected to one of the vertical signal lines and are arranged in a one-to-one relation with the vertical signal lines such that one of the sample-hold-signal converting circuits is connected to each of the switches and one or more of the sample-hold-signal converting circuits are shared between the switch and another switch, column positions of which are adjacent to each other, and
the control circuit includes two shift registers that separately control conduction and non-conduction of different switches among the switches in the switch circuits corresponding to each other according to a control signal from an outside.

8. The solid-state imaging device according to claim 1, wherein
the switch circuits include, as a set, first and second two analog switches, input terminals of which are respectively connected in parallel to one of the vertical signal lines, the sample-hold-signal converting circuits arranged at a column proximal end and a column terminal end being connected to each of output terminals corresponding thereto of the first analog switch located at the column proximal end and the second analog switch located at the column terminal end of the two analog switches in the switch circuits arranged at the column proximal end and the column terminal end, and, in each of the switch circuits between the second analog switch in the switch circuit arranged at the column proximal end and the first analog switch in the switch circuit arranged at the column terminal end, one of the sample-hold-signal converting circuits being connected in common to output terminals of the first analog switch in the switch circuit and the second analog switch in another switch circuit adjacent on a column proximal end side, and
the control circuit includes a multi-input NAND circuit that sets an output level to a signal level corresponding thereto according to whether a first control signal including a predetermined number of bits from an outside designates a column position of the control circuit, a first NOR circuit, one input of which is a second control signal that indicates presence or absence of operation designation from the outside with a binary signal level and the other input of which is an output of the multi-input NAND circuit, a second NOR circuit, one input of which is an output of another control circuit connected to a ground on the column proximal end side and adjacent on the column proximal end side between the column proximal end side and a column terminal end side and the other input of which is an output of the first NOR circuit, and a logic inversion circuit that logically inverts and outputs an output of the second NOR circuit, an output of the logic inversion circuit being input to respective one control terminals of the two analog switches and becoming the output to the other control circuit adjacent on the column terminal end side, and the output of the second NOR circuit being input to respective other control terminals of the two analog switches.

9. The solid-state imaging device according to claim 1, wherein
the switch circuits include, as a set, first and second two analog switches, input terminals of which are respectively connected in parallel to one of the vertical signal lines, the sample-hold-signal converting circuits arranged at a column proximal end and a column terminal end being connected to each of output terminals corresponding thereto of the first analog switch located at the column proximal end and the second analog switch located at the column terminal end of the two analog switches in the switch circuits arranged at the column proximal end and the column terminal end, and, in each of the switch circuits between the second analog switch in the switch circuit arranged at the column proximal end and the first analog switch in the switch circuit arranged at the column terminal end, one of the sample-hold-signal converting circuits being connected in common to output terminals of the first analog switch in the switch circuit and the second analog switch in another switch circuit adjacent on a column proximal end side, and
the control circuit includes a multi-input NAND circuit that sets an output level to a signal level corresponding thereto according to whether a first control signal including a predetermined number of bits from an outside designates a column position of the control circuit, a first NOR circuit, one input of which is a second control signal that indicates presence or absence of operation designation from the outside with a binary signal level and the other input of which is an output of the multi-input NAND circuit, a second NOR circuit, one input of which is an output of another control circuit connected to a ground on a column terminal end side and adjacent on the column terminal end side between the column proximal end side and the column terminal end side and the other input of which is an output of the first NOR circuit, and a logic inversion circuit that logically inverts and outputs an output of the second NOR circuit, an output of the logic inversion circuit being input to respective one control terminals of the two analog switches and becoming the output to the other control circuit adjacent on the column proximal end side, and the output of the second NOR circuit being input to respective other control terminals of the two analog switches.

10. The solid-state imaging device according to claim 1, wherein
the switch circuits include, as a set, first and second two analog switches, input terminals of which are respectively connected in parallel to one of the vertical signal lines, a column number of which is an even number, and third and fourth two analog switches, input terminals of which are respectively connected to one of the vertical signal lines, a column number of which is an odd number, in the switch circuits on an even number column side and an odd number column side, the sample-hold-signal converting circuits arranged at an even number column proximal end and an odd number column proximal end being connected to each of output terminals corresponding thereto of the first and third analog switches located at a column proximal end of the two analog switches in the switch circuits arranged at the column proximal end and the sample-hold-signal converting circuits arranged at an even number column terminal end and an odd number column terminal end being connected to each of output terminals corresponding thereto of the second and fourth analog switches located at a column terminal end of the two analog switches in the switch circuits arranged at the column terminal end, in each of the switch circuits between the second analog switch in the switch circuit arranged at the column proximal end on the even number column side and the first analog switch in the switch circuit arranged at the column terminal end, one of the sample-hold-signal converting circuits being connected in common to output terminals of the first analog switch in the switch circuit and the second analog switch in another switch circuit adjacent on a column proximal end side in order of a column position of the even number columns, and, in each of the switch circuits between the third analog switch in the switch circuit arranged at the column proximal end on the odd number column side and the fourth analog switch in the switch circuit arranged at the column terminal end, one of the sample-hold-signal converting circuits being connected in common to output terminals of the third analog switch in the switch circuit and the fourth analog switch in another switch circuit adjacent on the column proximal end side in order of a column position of the odd number columns, and
the control circuit includes a multi-input NAND circuit that sets an output level to a signal level corresponding thereto according to whether a first control signal including a predetermined number of bits from an outside designates a column position of the control circuit, a first NOR circuit, one input of which is a second control signal that indicates presence or absence of operation designation from the outside with a binary signal level and the other input of which is an output of the multi-input NAND circuit, a second NOR circuit, one input of which is an output of another control circuit connected to a ground on the column proximal end side and adjacent on the column proximal end side between the column proximal end side and a column terminal end side and the other input of which is an output of the first NOR circuit, and a logic inversion circuit that logically inverts and outputs an output of the second NOR circuit, an output of the logic inversion circuit being input to respective one control terminals of the two analog switches in two switch circuits connected to two of the vertical signal lines, column number of which are continuous, and becoming the output to the other control circuit adjacent on the column terminal end side, and the output of the second NOR circuit being input to respective other control terminals of the two analog switches.

11. The solid-state imaging device according to claim 1, wherein
the switch circuits include, as a set, first and second two analog switches, input terminals of which are respectively connected in parallel to one of the vertical signal lines, a column number of which is an even number, and third and fourth two analog switches, input terminals of which are respectively connected to one of the vertical signal lines, a column number of which is an odd number, in the switch circuits on an even number column side and an odd number column side, the sample-hold-signal converting circuits arranged at an even number column proximal end and an odd number column proximal end being connected to each of output terminals corresponding thereto of the first and third analog switches located at a column proximal end of the two analog switches in the switch circuits arranged at the column proximal end and the sample-hold-signal converting circuits arranged at an even number column terminal end and an odd number column terminal end being connected to each of output terminals corresponding thereto of the second and fourth analog switches located at a column terminal end of the two analog switches in the switch circuits arranged at the column terminal end, in each of the switch circuits between the second analog switch in the switch circuit arranged at the column proximal end on the even number column side and the first analog switch in the switch circuit arranged at the column terminal end, one of the sample-hold-signal converting circuits being connected in common to output terminals of the first analog switch in the switch circuit and the second analog switch in another switch circuit adjacent on a column proximal end side in order of a column position of the even number columns, and, in each of the switch circuits between the third analog switch in the switch circuit arranged at the column proximal end on the odd number column side and the fourth analog switch in the switch circuit arranged at the column terminal end, one of the sample-hold-signal converting circuits being connected in common to output terminals of the third analog switch in the switch circuit and the fourth analog switch in another switch circuit adjacent on the column proximal end side in order of a column position of the odd number columns, and
the control circuit includes a multi-input NAND circuit that sets an output level to a signal level corresponding thereto according to whether a first control signal including a predetermined number of bits from an outside designates a column position of the control circuit, a first NOR circuit, one input of which is a second control signal that indicates presence or absence of operation designation from the outside with a binary signal level and the other input of which is an output of the multi-input NAND circuit, a second NOR circuit, one input of which is an output of another control circuit connected to a ground on a column terminal end side and adjacent on the column terminal end side between the column proximal end side and the column terminal end side and the other input of which is an output of the first NOR circuit, and a logic inversion circuit that logically inverts and outputs an output of the second NOR circuit, an output of the logic inversion circuit being input to respective one control terminals of the two analog switches in two switch circuits connected to two of the vertical signal lines, column number of which are continuous, and becoming the output to the other control circuit adjacent on the column terminal end side, and the output of the second NOR circuit being input to respective other control terminals of the two analog switches.

12. The solid-state imaging device according to claim 1, wherein
the switch circuits include, as a set, first, second, and third three analog switches, input terminals of which are respectively connected in parallel to one of the vertical signal lines, the sample-hold-signal converting circuits arranged at a column proximal end and a column terminal end being connected to each of output terminals corresponding thereto of the first analog switch located at the column proximal end and the third analog switch located at the column terminal end of the three analog switches in the switch circuits arranged at the column proximal end and the column terminal end, one of the sample-hold-signal converting circuits being connected in common to an output terminal of the second analog switch in the switch circuit arranged at the column proximal end and an output terminal of the third analog switch in another switch circuit adjacent on a column terminal end side in order of column positions, one of the sample-hold-signal converting circuits being connected in common to an output terminal of the second analog switch in the switch circuit arranged at the column terminal end and an output terminal of the first analog switch in another switch circuit adjacent on a column proximal end side in order of column positions, and, in each of the switch circuits between the third analog switch in the switch circuit arranged at the column proximal end and the first analog switch in the switch circuit arranged at the column terminal end, one of the sample-hold-signal converting circuits being connected in common to output terminals of the second analog switch in the switch circuit, the third analog switch in another switch circuit adjacent on the column proximal end side, and the first analog switch in another switch circuit adjacent on a column proximal end side, and
the control circuit includes a first control circuit with the other switch circuit set on the column proximal end side, a second control circuit with the other switch circuit set on the column terminal end side, and a NAND circuit to which outputs generated by the first and second control circuits for each of the switch circuit are input, the first control circuit including a first multi-input NAND circuit that sets an output level to a signal level corresponding thereto according to whether a first control signal including a predetermined number of bits from an outside designates a column position of the control circuit, a first NOR circuit, one input of which is a second control signal that indicates presence or absence of operation designation from the outside with a binary signal level and the other input of which is an output of the first multi-input NAND circuit, a second NOR circuit, one input of which is an output of another control circuit connected to a ground on the column proximal end side and adjacent on the column proximal end side between the column proximal end side and the column terminal end side and the other input of which is an output of the first NOR circuit, and a first logic inversion circuit that logically inverts an output of the second NOR circuit and outputs the output to another control circuit adjacent on the column terminal end side, and the second control circuit including a second multi-input NAND circuit that sets an output level to a signal level corresponding thereto according to whether the first control signal from the outside designates a column position of the control circuit, a third NOR circuit, one input of which is the second control signal from the outside and the other input of which is an output of the second multi-input NAND circuit, a fourth NOR circuit, one input of which is an output of another control circuit connected to a ground on the column terminal end side and adjacent to the column terminal end side between the column proximal end side and the column terminal end side and the other input of which is an output of the third NOR circuit, and a second logic inversion circuit that logically inverts an output of the fourth NOR circuit and outputs the output to another control circuit adjacent on the column proximal end side, two inputs of the NAND circuit being outputs of the fourth NOR circuit, an output of the fourth NOR circuit being directly input to one control terminal of the first analog switch among the three analog switches and being input to the other control terminal with logic thereof inverted, an output of the NAND circuit being directly input to one input terminal of the second analog switch and being input to the other input terminal with logic thereof inverted, an output of the second NOR circuit being directly input to one control terminal of the third analog switch and being input to the other control terminal with logic thereof inverted.

13. The solid-state imaging device according to claim 1, wherein
the switch circuits include, as a set, first and second two analog switches, input terminals of which are respectively connected in parallel to one of the vertical signal lines, the sample-hold-signal converting circuits arranged at a column proximal end and a column terminal end being connected to each of output terminals corresponding thereto of the first analog switch located at the column proximal end and the second analog switch located at the column terminal end of the two analog switches in the switch circuits arranged at the column proximal end and the column terminal end, and, in each of the switch circuits between the second analog switch in the switch circuit arranged at the column proximal end and the first analog switch in the switch circuit arranged at the column terminal end, one of the sample-hold-signal converting circuits being connected in common to output terminals of the first analog switch in the switch circuit and the second analog switch in another switch circuit adjacent on a column proximal end side, and
the control circuit includes shift registers that have shift stages provided in a one-to-one relation with the switch circuits and to which a control signal from an outside is input from the column proximal end side or a column terminal end side, an output of the shift stage corresponding to the two analog switches in one switch circuit among the switch circuits being directly input to one control terminals of the two analog switches and input to the other control terminals with logic thereof inverted.

14. The solid-state imaging device according to claim 1, wherein
the switch circuits include, as a set, first and second two analog switches, input terminals of which are respectively connected in parallel to one of the vertical signal lines, a column number of which is an even number, and third and fourth two analog switches, input terminals of which are respectively connected to one of the vertical signal lines, a column number of which is an odd number, in the switch circuits on an even number column side and an odd number column side, the sample-hold-signal converting circuits arranged at an even number column proximal end and an odd number column proximal end being connected to each of output terminals corresponding thereto of the first and third analog switches located at a column proximal end of the two analog switches in the switch circuits arranged at the column proximal end and the sample-hold-signal converting circuits arranged at an even number column terminal end and an odd number column terminal end being connected to each of output terminals corresponding thereto of the second and fourth analog switches located at a column terminal end of the two analog switches in the switch circuits arranged at the column terminal end, in each of the switch circuits between the second analog switch in the switch circuit arranged at the column proximal end on the even number column side and the first analog switch in the switch circuit arranged at the column terminal end, one of the sample-hold-signal converting circuits being connected in common to output terminals of the first analog switch in the switch circuit and the second analog switch in another switch circuit, a column number of an even number column of which is continuous on the column proximal end side, and, in each of the switch circuits between the third analog switch in the switch circuit arranged at the column proximal end on the odd number column side and the fourth analog switch in the switch circuit arranged at the column terminal end, one of the sample-hold-signal converting circuits being connected in common to output terminals of the third analog switch in the switch circuit and the fourth analog switch in another switch circuit adjacent on the column proximal end side in order of a column position of the odd number columns, and
the control circuit includes shift registers that have shift stages provided in a one-to-one relation with two switch circuits connected to two of the vertical signal lines, column numbers of which are continuous, in the switch circuits, and to which a control signal from an outside is input from the column proximal end side or a column terminal end side, an output of the shift stage corresponding to the two switch circuits being directly input to one control terminals of the two analog switches in the two switch circuits and input to the other control terminals with logic thereof inverted.

15. The solid-state imaging device according to claim 1, wherein
the switch circuits include, as a set, first, second, and third three analog switches, input terminals of which are respectively connected in parallel to one of the vertical signal lines, the sample-hold-signal converting circuits arranged at a column proximal end and a column terminal end being connected to each of output terminals corresponding thereto of the first analog switch located at the column proximal end and the third analog switch located at the column terminal end of the three analog switches in the switch circuits arranged at the column proximal end and the column terminal end, one of the sample-hold-signal converting circuits being connected in common to an output terminal of the second analog switch in the switch circuit arranged at the column proximal end and an output terminal of the third analog switch in another switch circuit adjacent on a column terminal end side in order of column positions, one of the sample-hold-signal converting circuits being connected in common to an output terminal of the second analog switch in the switch circuit arranged at the column terminal end and an output terminal of the first analog switch in another switch circuit adjacent on a column proximal end side in order of column positions, and, in each of the switch circuits between the third analog switch in the switch circuit arranged at the column proximal end and the first analog switch in the switch circuit arranged at the column terminal end, one of the sample-hold-signal converting circuits being connected in common to output terminals of the second analog switch in the switch circuit, the third analog switch in another switch circuit adjacent on the column proximal end side, and the first analog switch in another switch circuit adjacent on a column proximal end side, and
the control circuit includes first and second shift registers that have shift stages provided in a one-to-one relation with the switch circuits connected and to which a control signal from an outside is input from the column proximal end side or a column terminal end side and a plurality of NAND circuits to which outputs of the shift registers corresponding thereto of the first and second shift registers are input, an output of the shift stage corresponding to the three analog switches in one switch circuit among the switch circuits being directly input to one control terminal of the first analog switch and input to the other control terminal with logic thereof inverted, an output of the NAND circuit corresponding thereto being directly input to one control terminal of the second analog switch and input to the other control terminal with logic thereof inverted, and an output of the shift register corresponding thereto being directly input to the third analog switch and input to the other control terminal with logic thereof inverted.

16. The solid-state imaging device according to claim 1, wherein the control circuit is provided in a one-to-one relation with each of the switch circuits.

17. The solid-state imaging device according to claim 1, wherein a singularity of the control circuit is provided for the switches.

18. The solid-state imaging device according to claim 1, wherein a first control signal designating a column position with a predetermined number of bits i+1 and a second control signal indicating presence or absence of operation designation with a binary level signal are input to the control circuit from an outside, and there is a relation 2ⁱ<n≦2ⁱ⁺¹ between the predetermined number of bits i+1 and a number of columns n.
